(19) United States
(12) Patent Application Publication
(10) Pub. No.: US 2012/0210406 A1
(43) Pub. Date: Aug. 16, 2012

(54) FORMING CREDENTIALS

(75) Inventors: Jan L. Camenisch, Thalwil (CH); Thomas R. Gross, Zurich (CH)

(73) Assignee: International Business Machines Corporation, Armonk, NY (US)

(21) Appl. No.: 13/453,374

(22) Filed: Apr. 23, 2012

Related U.S. Application Data
(62) Division of application No. 12/206,377, filed on Sep. 8, 2008.

(51) Int. Cl. G06F 21/00

(52) U.S. Cl. 726/6; 726/5

(57) ABSTRACT

Techniques are disclosed for issuing inoperative credentials, and making the inoperative credential operative at a subsequent point in time. For example, a method of forming a credential comprises the step of forming, at a first point in time, an inoperative credential. The inoperative credential is adapted to become operative, at a second point in time, to form an operative credential. The second point in time occurs after the first point in time.

### CROSS-REFERENCE TO RELATED APPLICATION

This application is a divisional of U.S. patent application Ser. No. 12/206,377 filed on Sep. 8, 2008, the disclosure of which is incorporated by reference herein in its entirety.

### FIELD OF THE INVENTION

The present invention relates generally to identification and credential systems, and more particularly the invention relates to activating and updating credentials.

### BACKGROUND OF THE INVENTION

Some countries have a significant deployment of national electronic identity (eID) cards. Belgium citizens use the eID card for identification, authentication and authorization for many public services, for example, secure online tax form declaration, official document requests, electronic submission of court case conclusions, as well as access to the public library, swimming pool and other community services.

The eID card and infrastructure can also be used by enterprises to make electronic applications and services secure. Vendors use, or may use, the eID card and infrastructure to provide services, for example, secure online ticket purchases, online opening of e-commerce accounts, and as a qualified signature for contract signing.

For security reasons, companies and countries often have policies that eID cards must be read-only. Thus, when holder attributes change during some eID card validity period, the eID card must be reissued. There are costs associated with reissuing an eID card.

### SUMMARY OF THE INVENTION

Principles of the invention provide, for example, methods and apparatus for forming inoperative credentials, issuing inoperative credentials, and making the inoperative credentials operative at a subsequent point in time. An inoperative credential is made operative when a triggering event occurs qualifying or entitling the inoperative credential holder to the operative credential.

For example, in accordance with one aspect of the invention, a method is provided for forming a credential. The method comprises the step of forming, at a first point in time, an inoperative credential. The inoperative credential is adapted to become operative, at a second point in time, to form an operative credential. The second point in time occurs after the first point in time.

In accordance with another aspect of the invention, an apparatus is provided. The apparatus comprises at least one integrated circuit. The at least one integrated circuit comprising an inoperative credential issued at a first point in time. The apparatus is adapted for making the inoperative credential operative, at a second point in time, to form an operative credential. The second point in time occurs after the first point in time.

Advantages of the invention include, for example, issuing inoperative credentials, as well as any operative credential, at the time that an electronic identity card is issued. Operative and inoperative credentials are issued only once. Therefore, electronic identity cards do not need to be reissued at a later time to add, remove or change credentials, thus eliminating costs associated with electronic identity card reissue.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a general method of forming a credential according to an exemplary embodiment of the invention.

FIG. 2 illustrates a bound proof method of forming a credential according to an exemplary embodiment of the invention.

FIG. 3 illustrates a strong RSA algorithm bound proof method of forming a credential according to an exemplary embodiment of the invention.

FIG. 4 illustrates an encryption method of forming a credential according to an exemplary embodiment of the invention.

FIG. 5 illustrates a hash chain encryption method of forming a credential according to an exemplary embodiment of the invention.

FIG. 6 is a cross-sectional view depicting an exemplary packaged integrated circuit adapted to perform at least part of a method of the invention, according to an embodiment of the present invention.

FIG. 7 illustrates a computer system in accordance with which one or more components/steps of the techniques of the invention may be implemented, according to an embodiment of the invention.

### DETAILED DESCRIPTION OF THE INVENTION

An attribute, as used herein, is a feature, a characteristic, a status, an attainment, a privilege or an entitlement of the holder. Examples of attributes are age, gender, marital status, security status, a collage degree, driving privileges, and social welfare entitlement. The acquirement or occurrence of an attribute may form a trigger.

A card application, as used herein, is an application that uses an eID card, smartcard or similar device. A card application is, for example, a function, a method, an apparatus, a card application system, a computer, or computer system that uses the eID card to ascertain the identity, attributes or credentials of the holder.

A credential, as used herein, is an attestation of qualification, competence, or authority issued to an individual by a third party with a relevant de jure or de facto authority or assumed competence to do so. Examples of credentials include academic diplomas, academic degrees, certifications, security clearances, identification documents, badges, passwords, holder names, keys, powers of attorney, employment, and so on. As used herein, the term credential, when not directly preceded by the word inoperative or inactive, means an active or operative credential, and is used synonymously and interchangeably with the terms active credential and operative credential. The terms inactive credential and inoperative credential, as used herein, have the same meaning and are used interchangeably.

An electronic identity card (eID card), as used herein, is a proof of identity. An electronic identity card is, for example, an official or a government issued electronic proof of identity. The eID card is referred to herein as the card. It also enables the possibility to sign electronic documents with a legal signature. The card typically comprises an integrated circuit chip containing, for example, some or all of the information that is visually legible on the card, an electron picture of the person the card was issued to (holder), the address of the holder, nationality of the holder, birth place and date of the holder, gender of the holder, card number, card validity dates, identification number of the holder, status of the holder, fingerprint of the holder, and identity and signature keys and certificates. The integrated circuit chip within the eID card can also contain status information, for example, driving privileges, marital status, age related data, employment status. Cards are used, for example, for electronic authentication of the card holder, for electronic authentication of the eID card itself, for obtaining public and private service, access to computer and computer systems, and proof of status. An eID card may comprise or contain, for example, credentials, operative or inoperative. Other examples of eID cards are corporate ID cards, healthcare cards, insurance cards, bank cards, credit cards, and attribute-enabled banking and credit cards.

The Rivest, Shamir and Adleman (RSA) algorithm is an algorithm for public-key cryptography. It is suitable for signing as well as encryption. RSA is widely used in electronic commerce protocols. RSA involves a public key and a private key. The public key can be known to everyone and is used for encrypting messages. Messages encrypted with the public key can only be decrypted using the private key. The public and private keys are generated by methods known in the art. The name RSA is the initials of the surnames of the original developers of the RSA algorithm. A description of an exemplary RSA algorithm is contained in the reference: R. Rivest, A. Shamir, and L. Adleman, “A Method for Obtaining Digital Signatures and Public-Key Cryptosystems,” Communications of the ACM, Vol. 21 (2), pages 120-126, 1978, the disclosure of which is incorporated herein by reference.

The flexible RSA problem is the task of performing the RSA private-key operation given only the public key, that is, to find the private key. A fast means of solving the RSA problem would yield a method for breaking all RSA-based public-key encryption and signing systems.

The strong RSA assumption states that the RSA problem is intractable. More specifically, given a RSA modulus n of unknown factorization, and a number z, it is infeasible to find any pair (u,e) such that u^{e}=z mod n, where z=x^{e}. The strong RSA assumption is described in the reference: E. Fujisaki and T. Okamoto, “Statistical Zero Knowledge Protocols to Prove Modular Polynomial Relations,” Burt Kaliski, editor, Advances in Cryptology—Eurocrypt 1997, Vol. 1294 of Lecture Notes in Computer Science, pages 16-30, Springer Verlag, 1997, the disclosure of which is incorporated herein by reference.

A holder, as used herein, is the person or entity that the card was issued to.

A smartcard, chip card, or integrated circuit card (ICC), is defined as any substantially pocket-sized card with an embedded integrated circuit which can process information.

A trigger, as used herein, is a milestone, an attribute, a characteristic, a status, an attainment, a privilege, an entitlement, an event or an activation that triggers or causes an inactive credential to become an active credential. Examples of triggers are attainment of a specific age, marital status, security status, school degree, driving privilege, social welfare entitlement, and activation by an activation code. When an inactive credential is changed to an active credential, the inactive credential is said to be triggered. When a first active credential is updated or changed to a second active credential, the first active credential is said to be triggered.

Identifications and credentials, for example, those having long durations of validity, are, for example, government-issued eID cards and corporate identification and/or credential cards. Electron identity cards can identify individuals to an enterprise, a government agency, a corporation, a charitable organization, a computer, and another individual. However, the invention is not restricted to personal identification and/or credential cards. Features of the invention can benefit, for example, computers, cellular phones, and other devices requiring electronic identification, authentication, or secure access.

Attributes, such as a date of birth of the holder, may be encoded in a credential. When a card application needs to know the age, or age range of the holder, it must compute the age from the date of birth with relation to the current date. In the age example, the card application calculates that the date of birth of the holder is earlier than the current date minus the required age. This is a relatively inefficient method because it involves calculation for each such use. Furthermore, such calculation methods are not generally applicable to the more general case of forming activated credentials without card reissue.

It is a desirable goal to issue inoperative or inactive credentials, as well as any operative or active credential, at enrollment or at the time that an eID card is issued, such that operative or active and inoperative or inactive credentials are issued once, and such that the eID card does not need to be reissued at a later time to add, remove or change credentials. Certain European countries have a policy that an eID is issued once and is read-only afterwards. To obtain the goal, inoperative credentials on a card may be pre-issued for a specific duration of card validity (validity duration), for example, 5 years.

Aspects of the invention are advantageous, for example, enabling inoperative or inactive credentials to be activated or to be made operative, and enabling credentials to be updated without reissuing a card, thereby avoiding the cost of card reissue. According to an embodiment of the invention, inoperative credentials and any operative credentials are issued once, and inoperative credentials are inoperative at the time of issue, and have the ability to be conditionally activated at a future time. Activation of inoperative credentials at the future time occurs due to a trigger, for example, a specific point or date in time being reached, a pre-specified event occurring, or the providing of an activation code to the card.

As an example, consider the following case that includes updating a credential. An embodiment of the invention comprises an operative or inoperative credential, for example, age credential, comprising a set of credential classes associated with attribute classes, for example, attribute classes associated with attainment of specific years of age, as indicated by indicators stored within a card, for example, age indicators. The age indicators are, for example, a set of age breakpoints: sixteen, eighteen, twenty-one, and fifty-five years old. When the holder attains a specific indicator, for example, the age of a breakpoint, the credential, for example, the age credential, is updated to the current credential class, without reissuing the card. Updated an age credential only a few times during the validity duration is more efficient and more cost effective than re-issuing the card at the each age breakpoint, or, for transactions requiring an age related credential, storing a date of birth within the card and re-computing the age of the holder as a function of the current date. In this embodiment, all the attribute classes are issued at the time of card issue. Each of the attribute classes may be subsequently activated at the appropriate time or by the appropriate event or trigger, for example attaining a specific age. If the card, comprising the age attribute, is issued before the first age breakpoint, the card comprises, at the time of issue, an inoperative age credential. If the card, comprising the age attribute, is issued after the first age breakpoint, the card comprises an operative age credential.

For another example, a card, at the time of issue, has one or more inoperative credential, for example, a driver's license, a social welfare credential, and a marriage credential. One or more of these credentials get activated when the holder attains a related triggering milestone or trigger, for example, passing a driver's test, qualifying for social welfare or getting married.

Aspects of the invention are, for example, issuing inoperative credentials in advance, and rendering the inoperative credentials inoperative or inaccessible to card applications at the time of issue and until associated triggers, for example, a time or date, an event, or an activation code, occur.

FIG. 1 illustrates a method 100 of forming a credential. The first step 150 of the method 100 is an optional step. It is the optional step of forming credential classes. Credential classes are the classes that a credential may have including the class when the credential is first made operative and classes associated with subsequent upgrades or class changes of the credential. Credential classes are typically associated with attribute classes. Each related attributed class typically corresponds to an attribute, for example, age, but different characteristics or manifestations of the attribute, for example, different ages. A credential class is typically formed when a credential can be updated, by the occurrence of a trigger, at a time occurring after activation, as in the age related example above, wherein the credential, in this example an age credential, comprises a class for each related trigger, in this example, a class for the attainment of each age breakpoint. If the credential is one that is initially inoperative and can be conditionally made operative at some point in time after issue, but not subsequently updated, credential classes are not needed.

The second step 160 of the method 100 is forming an inoperative credential. The step of forming the inoperative credential 160, typically comprises defining the credential and it related trigger, or related triggers if the credential has credential classes. The step 160 further comprises storing the inoperative credential within a, eID card. The step 160 further comprises a method for the inoperative credential to become operative, for example, at least part of the method of card access control, at least part of the method wherein the credential is bound to a second proof, and at least part of the method wherein the inoperative credential is encrypted.

The third step 170 of the method 100 is issuing the inoperative credential. The inoperative credential is issued to an entity, for example, an individual, an organization, a computer or a company. The entity is the card holder. The inoperative credential is typically issued in the form of an eID card comprising the inoperative credential. The issuing of the card comprises the issuing of the inoperative credential or, alternately, an operative credential that may be updated.

The fourth and last step 180 of the method 100 is making the inoperative credential operative to form an operative credential. Making the inoperative credential operative occurs in response to an occurrence of a trigger. When the trigger occurs a predetermined method changes the inoperative credential to an operative credential. The predetermined method is, for example, at least part of the method of card access control, at least part of the method wherein the credential is bound to a second proof, and at least part of the method wherein the inoperative credential is encrypted. Making the inoperative credential operative can comprise an entry stored within the card by the credential system or by an application system which has become aware that the trigger has occurred. Alternately, no entry is stored within the card. The credential system or application system knows and remembers that the trigger has occurred. In either case, when the card with the operative credential is used in the appropriate credential system or application system, that the credential is operative is known and the credential is operative and useable. When there are credential classes, step 180 may, alternately, be updating a first operative credential to form an operative second credential.

The inoperative credential may be related to, for example, one of the following methods.

(a) Card access control method: The inoperative credential is stored within the card, protected by card access control, and triggered, that is, changed into an operative credential, when the corresponding trigger occurs.

(b) Bound to a second proof method: The inoperative credential is bound to a second proof system for which the holder must produce a witness of proof that the holder holds or possesses an operative second credential, and wherein the holder does not yet have the witness of proof.

(c) Encryption method: The inoperative credential is encrypted, and can only be decrypted once the corresponding trigger occurs.

Credentials according to (a) above require trust in the hardware of the card or application. Credentials according to (c) above are secure without trusting the hardware of the card or application.

The following is a description of the card access control method, (a) above. In the third step 170, the step of the issuing of the inoperative credential, of method 100, The card stores the inoperative credential or credentials and optionally the associated attribute that were formed in the second step 160, the step of forming the inoperative credentials, of method 100. As part of the fourth step 180, the step of making the inoperative credential operative, of method 100, the card has access control in place that checks for triggers. As soon as the trigger occurs, the inoperative credential and optionally attribute is activated becoming an operative credential, that is, the credential is flagged as usable, and can be leveraged or used by the holder and card applications. For instance, the current date signed by a trusted authority can be used to change an inoperative credential to an operative credential. For example, other triggers are the current place, and attributes of a SmartCard reader certificate or the receiving party.

The following is a description of the bound to a second proof method, (b) above. The inoperative credential can on only be changed to an operative credential if the holder can provide a witness of proof associated with the inoperative credential. An accumulator system is used to provide an activation code or witness to the holder or to the card of the holder.

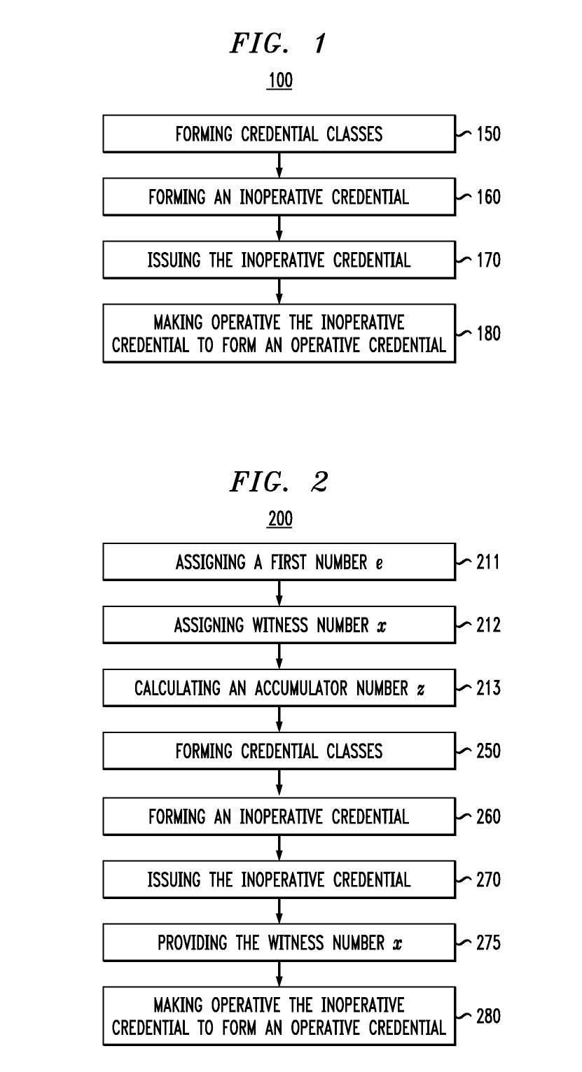

FIG. 2 illustrates a bound proof method 200 for forming a credential wherein the credential is bound to a second proof. The bound proof method 200 is an example of the method 100 of forming a credential. The fourth step 250, forming credential classes, of the bound proof method 200 is optional and is similar to the first step 150, forming credential classes, of the method 100 of forming a credential. Likewise, the fifth step 260, the sixth step 270, and the eight step 280 of the bound proof method 200 are similar to the second step 160, the third step 170 and the fourth step 180, respectively, of the method 100 of forming a credential.

The inoperative credential is coupled to a cryptographic method comprises: a public accumulator comprising a set of public accumulator numbers Z comprising a plurality of public accumulator numbers zᵢ; a set of prime numbers E comprising a plurality of prime numbers eᵢ; and a set of witness numbers X comprising a plurality of witness numbers xᵢ. For each prime number eᵢ, there is a corresponding witness number xᵢ, such that zᵢ=xᵢ^{e}(that is, zᵢ=xᵢ to the exponent eᵢ).

The first step 211 of the bound proof method 200, is assigning a first number e to the inoperative credential. In the embodiment described herein e is a prime number eⱼ. Therefore, an inoperative credential within a card comprises a prime number eⱼ The prime number eⱼ is one of the plurality of prime numbers eᵢ. Alternately, the inoperative credential within the card comprises a pointer to the prime number eⱼ.

The second step 212 of the bound proof method 200, is assigning a witness number x to the inoperative credential. In the embodiment described herein xⱼ is the witness number. The witness number xⱼ is one of the plurality of witness numbers xᵢ. The third step 213 of the bound proof method 200, is calculating an accumulator or public accumulator number z corresponding to the inoperative credential. In the embodiment described herein, zⱼ is the public accumulator number. The public accumulator number z uniquely corresponds to a set of two numbers xⱼ and eⱼ. Correspondence is according to the formula: zⱼ=xⱼ^{e}^{ⱼ}. The public accumulator number zⱼ is one of the plurality of public accumulator numbers zᵢ.

The fifth step 260 of the method 200 is forming an inoperative credential. The step of forming the inoperative credential 260 typically comprises defining the credential and it related trigger, storing the inoperative credential within an eID card, and a method for the inoperative credential to become operative. The inoperative credential contains the first number e, for example, the prime number eⱼ, does not contain witness number x, for example, xⱼ, and does not contain public accumulator number z, for example, zⱼ.

The method for the inoperative credential to become operative is described. The holder, whenever he leverages or used the credential, is required to prove that the public accumulator number zⱼ is part of the set of public accumulator numbers Z, that is, one of the plurality of public accumulator numbers zᵢ. As long as the holder, or the card of the holder, does not possess the witness number xⱼ, corresponding to the prime number eⱼ, it is not feasible to compute the public accumulator number zⱼ.

The seventh step 275 of the bound proof method 200 is providing the witness number x. After the trigger occurs, an issuing authority provides the witness number xⱼ to the holder or the card of the holder.

The eight and last step 280 of the bound proof method is making the inoperative credential operative to form an operative credential. The holder or the card of the holder possesses the witness number xⱼ and is enabled to prove that the accumulator number zⱼ is within the set of public accumulator numbers Z. The inoperative credential becomes an operative credential.

The illustrative embodiments described has the correspondence between the prime number eⱼ and the public accumulator number z expressed as zⱼ=xⱼ^{e}^{ⱼ}. The invention is not so limited, the correspondence can more generally be expressed as zⱼ=ƒ(xⱼ, eⱼ), wherein zⱼ is a function of xⱼ and eⱼ, not necessarily the function expressed buy zⱼ=xⱼ^{e}^{ⱼ}. In this case, the correspondence between zᵢ and eᵢ is more generally be expressed as zᵢ=ƒ(xᵢ, eᵢ), wherein zᵢ is a function of xᵢ and eᵢ, not necessarily the function expressed by zᵢ=xᵢ^{e}^{ᵢ}.

An embodiment of the invention uses an RSA public key cryptography algorithm for forming the set of public accumulator numbers Z, the set of witness numbers X, and the set of prime numbers E. A description of an exemplary RSA algorithm is contained in the previously cited reference, “A Method for Obtaining Digital Signatures and Public-Key Cryptosystems.”

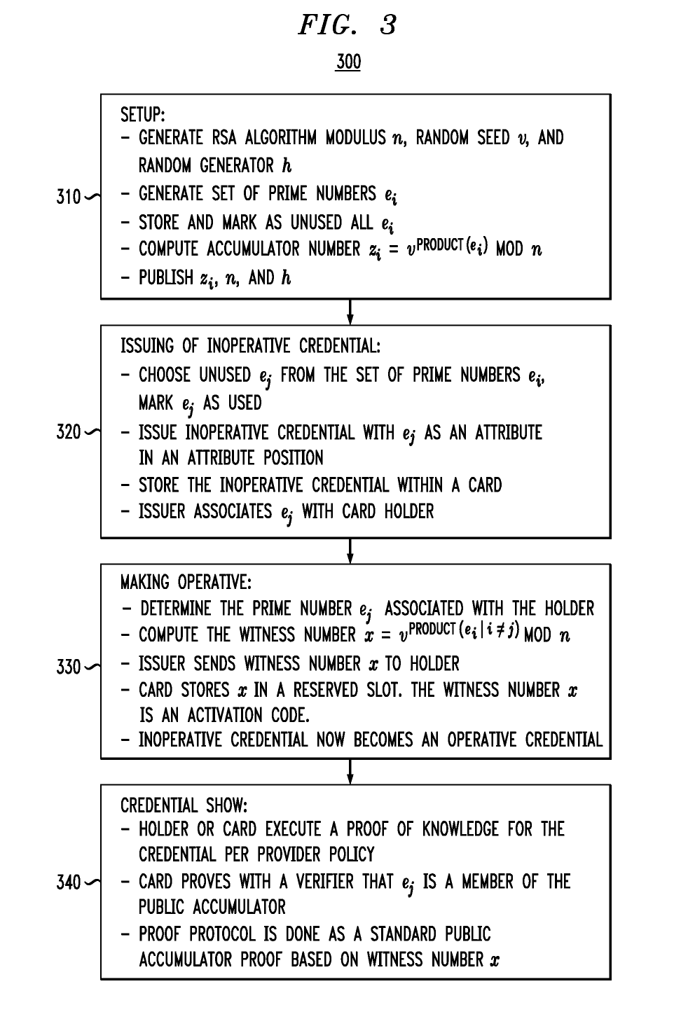

The following is a detailed description of a bound proof method according to an embodiment of the invention using an RSA public key cryptography algorithm, wherein the inoperative credential is bound to a second proof system. FIG. 3 illustrates a bound proof method using RSA 300. As shown in FIG. 3, the bound proof method using RSA 300 is divided into major steps of setup, issuing of inoperative credential, making operative, and using, or showing, the credential. Following are details of the bound method and the major steps.

The first major step 310 is setup. The issuer establishes a static cryptographic accumulator scheme as follows. The issuer generates an RSA algorithm having modulus n, choose a random seed number v, and choose a random generator number h, such that for all witness numbers xᵢ, xᵢ holds for: xᵢ in <h>. The issuer generates a set of random prime numbers eᵢ as numbers to be accumulated and associated with credentials. The issuer stores all prime numbers eᵢ, and marks all prime numbers eᵢ as unused. The issuer computes the public accumulator numbers zᵢ=v^{Π(e}^{ᵢ}⁾mod n (that is, zᵢ=v^{product (e}^{ᵢ}⁾mod n). The issuer then publishes n, and h and the set of zᵢ.

The second major step 320 is issuing of an inoperative credential. The issuer chooses an unused eⱼ which is within the set of random numbers eᵢ, and mark eⱼ as used. The issuer issues an inoperative credential as required in a credential system, comprising at least one attribute position having the prime number eⱼ an attribute, for example, at attribute position two. The inoperative credential is stored within a card. The card contains a reserved slot to store, at a later time, the witness number x. The issuer associates prime number eⱼ with the pseudonym (nym) or identification (ID) of the holder.

The third major step 330 is to making the inoperative credential operative to form an operative credential. The issuer knows or determines the prime number eⱼ associated with the holder. The issuer then computes the witness number x=v^{Π(e}^{ᵢ}^{|i≠j)}mod n (that is, x=v^{product (e}^{ᵢ}^{|i≠j)}mod n). The issuer sends witness number x to holder. The card stores witness number x in the reserved slot. The witness number x acts as an activation code. The inoperative credential now becomes an operative credential.

In an alternate embodiment of the third major step 330 the following is performed. The issuer chooses the public accumulator number z randomly in the major step of the setup 310. The issuer chooses eⱼ randomly in the major step of the issuing of inoperative credential 320. The issuer computes the witness number x as the eⱼ-th root of z mod n.

The fourth and last major step 340 is using, or showing, the credential. The credential may, for example, be an anonymous credential in the Camenisch-Lysyanskaya system. The Camenisch-Lysyanskaya system is described in the reference: J. Camenisch and A. Lysyanskaya, “Efficient Non-transferable Anonymous Multi-show Credential System with Optional Anonymity Revocation,” B. Pfitzmann, editor, Advances in Cryptology—Eurocrypt 2001, Vol. 2045 of Lecture Notes in Computer Science, pages 93-118, Springer Verlag, 2001, the disclosure of which is incorporated herein by reference. Such a credential is a Camenisch-Lysyanskaya signature on the credential values (c, e, s) which fulfills the formula, where only two attribute bases, a1 and a2, are shown for exemplary purposes:

d=c^{e}*a1^{r}*a2^{m}*b^{s}(mod n).

The modulus n is an RSA modulus computed from two safe prime numbers p and q. The values d, c, e, are the problem instance for the Strong RSA Assumption. d is public and chosen from the Quadratic Residues of n (QRₙ). e is a prime with bit-length of the security parameter. c is the computed result for the Strong RSA problem. The base b, chosen from QRₙ, generates the group for blinding the signature and hiding the attribute values. s is the blinding randomness chosen as integer in the size of the RSA modulus n. The bases a1 and a2 from <b>, thus also from QRₙ, are attribute bases with r being the master secret of the user and m being a message in the second attribute.

The holder and/or the card of the holder execute a proof of knowledge for the credential depending on the service provider policy. In addition, the card runs a proof protocol with a verifier that the number eⱼ, associated with the credential, is indeed a member of the public accumulator. The proof protocol that is run for the card is done as a standard public accumulator proof based upon the witness number x.

Consider a proof for a credential wherein the number eⱼ in the public accumulator is stored within the credential as a second attribute. The holder chooses a random number s and a generator g. For the publicly known generator h, the holder computes U1=x*h^{s} (note that x lies in <h>). Also, the holder computes U2=g^{s}. The holder sends U1, U2, and g to the verifier, in addition to the data sent for the normal credential show. The holder runs a zero-knowledge proof protocol with the verifier according to the following specification, wherein PK is notation for proof of knowledge in a standardized notation, by Camenisch and Stadler (see Camenisch and Stadler citation below) indicating that a proving user demonstrates knowledge of secret values epsilon, mu, rho, sigma, xi, delta:
PK{(epsilon, mu, rho, sigma, xi, delta). Epsilon, rho, and sigma are for normal credential show. Mu, xi, and delta are specific for the public accumulator proof.
d=c^{,epsilon}*a1^{rho}*a2^{mu}*b^{sigma}(mod n). This is the basic credential PK, with eⱼ at attribute 2.
AND z=U^{mu}*(1/h)^{xi}(mod n). This is a proof for knowledge for witness number x.
AND 1=U2^{mu}*(1/g)^{xi}(mod n). This proves relationship between xi, delta, and mu: xi=delta*mu.
AND U2=g^{delta}(mod n). This is a proof for knowledge of s.

The Camenisch and Stadler reference cited above is: J. Camenisch and M. Stadler, “Efficient Group Signature Schemes for Large Groups,” Burt Kaliski, editor, Advances in Cryptology—Eurocrypt 1997, Vol. 1296 of Lecture Notes in Computer Science, pages 410-424, Springer Verlag, 1997, the disclosure of which is incorporated herein by reference.

The following is a description of the encryption method, (c) above. The inoperative credential is encrypted on a card or credential system such that even if the card or credential system hardware is disassembled, the inoperative credential cannot be decrypted. The inoperative credential can only be decrypted once the corresponding trigger occurs. A decryption key is obtained as a value of a hash chain.

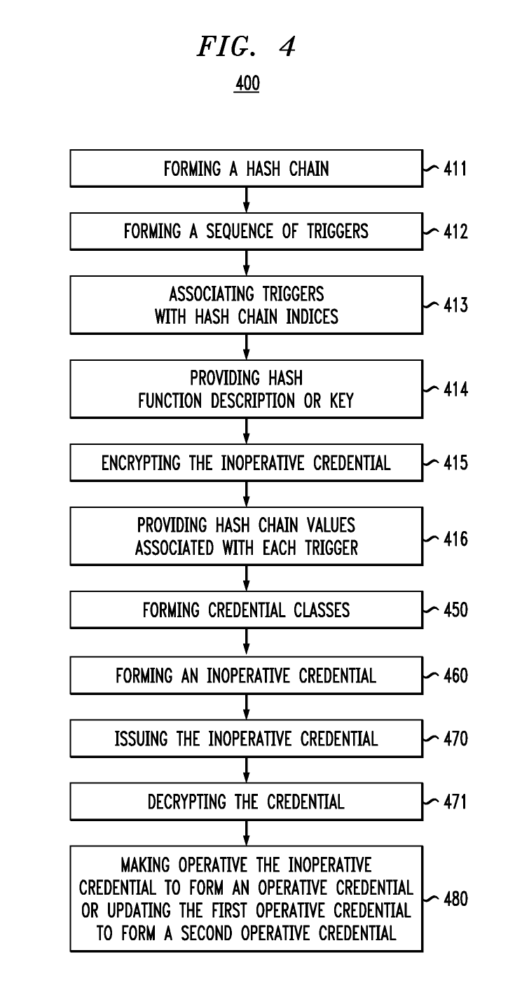

FIG. 4 illustrates an encryption method 400 according to an embodiment of the invention. The encryption method assumes that there is a plurality of triggers, and that the order in which the triggers will occur is known before the triggers occur. An inoperative credential can be made operative to form an operative credential, for example, a first operative credential. A first operative credential may be updated to form a second operative credential. Likewise the second operative credential may be updated to form a third operative credential, and so forth. The updating of each inoperative or operative credential is associated with one of the triggers within the plurality of triggers.

The first step 411 of the encryption method 400 is the formation of a hash chain in accordance with a hash function, for example, a reverse hash chain of a cryptographic one-way hash function. A reverse hash chain is, for example, a hash chain where the root r of the hash chain is associated with the most time-distant trigger. The issuing authority holds the root value of the hash chain in secret. The issuing authority pre-computes the whole hash chain.

The second step 412 is the forming of a time-order sequence of triggers. The issuer, that is, the issuing authority, orders the triggers in a time sequence, starting from the nearest in time and ending with the most distant in time.

In third step 413, the issuing authority associates the triggers, in sequence, with sequential indices of the reverse hash chain. The hash chain indices most closely related to the root r is associated with the trigger that is most distant in time. All triggers are associated, in order, with hash chain indices.

The fourth step 414 is the issuer providing or publishing a description or key of the hash function. The issuer does not provide the root of the hash function.

The fifth step 415 is the issue encrypting the inoperative credential. The inoperative credential is encrypted with a current value of the reversed hash chain.

The sixth step 416 is the issuer providing, or publishing, hash chain values associated with each trigger.

The seventh step 450 is forming the credential classes. The seventh step 450 is optional and similar to the first step 150 of method 100 (FIG. 1). Credential classes are the classes that a credential may have including the class when the credential is first made operative and classes associated with subsequent upgrades or class changes of the credential. Credential upgrades may be considered a new credential. For example, a first operative credential may be upgraded into a second operative credential. Each credential classes may be associated with an operative credential.

The eighth step 460 is the forming of the inoperative credential. The eighth step 460 similar to the second step 160 of method 100 (FIG. 1). The issuer defines the credential and the related trigger, or related triggers if the credential has credential classes. The issuing authority computes and/or looks up the encryption key for the triggers. The issuer encrypts the inoperative credential with the hash chain values as a key. The card cannot compute future values of the hash chain because one-way property of the hash functions.

The ninth step 470 is issuing the inoperative credential. The inoperative credential is stored within a card.

The tenth step 471 is decrypting the inoperative or first operative credential. The issuing authority publishes a new original hash value for each trigger considered. Once the index of the current trigger is larger than the index of the inoperative credential or the first operative credential, the card/credential system can decrypt the inoperative credential or the first operative credential based on the hash function.

The eleventh step 480 is making the inoperative credential operative to form an operative credential or updating the first operative credential to form a second operative credential. After an inoperative credential is decrypted, the inoperative credential changes to an operative credential. After a first operative credential is decrypted, the first operative credential is updated, for example, the first operative credential changes into a second operative credential. For each subsequent trigger, the card can compute the hash value by following the hash chain forward. The described hash chain encryption method does not require the card to store a value, other than the current value originally stored. After the trigger is reached, the decryption key can be re-computed based on publishes values.

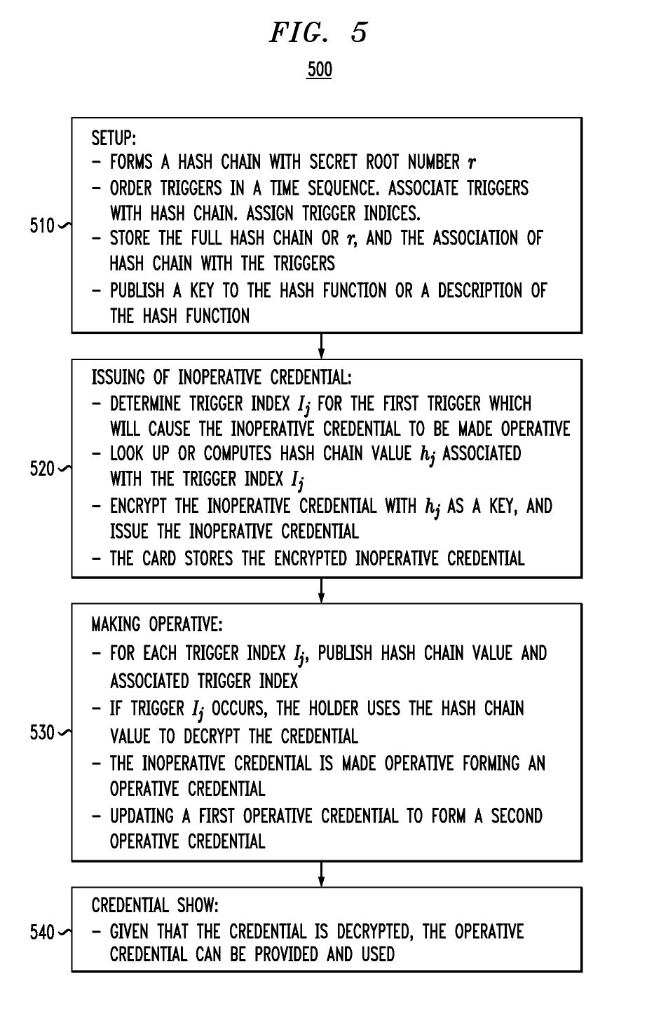

The following is a detailed description of a hash chain encryption method 500 according to an embodiment of the invention as shown in FIG. 5. The hash chain encryption method is divided into major steps of setup, issuing of inoperative credential, making operative, and using or showing the credential. Following are details of the hash chain method and the major steps:

The first major step 510 is setup. The issuer establishes a hash chain by choosing a keyed one-way hash function and a random secret root number r. The full hash chain, h1=H(r), h2=H(h1), h3=H(h2), . . . , is computed by the issuer. The issuer orders the trigger instants in a time sequence and associates h1 with the trigger most distant in the future, h2 with the trigger next nearest in time, and so forth. All triggers are associated systematically with the hash chain or with hash chain indices. All triggers are assigned a trigger index Iᵢ, wherein i is a number indicating the trigger. The issuer either stores the full hash chain or the root number r. The issuer also stores the association the hash chain or hash chain indices with the triggers. The issuer publishes a key to the hash function or a description of the hash function. Potentially, the issuer also publishes the hash chain value for the current trigger.

The second major step 520 is issuing of the inoperative credential. The issuer determines the trigger index Iⱼ, wherein j corresponds to first trigger that may occur in the future and cause the inoperative credential to become an operative credential. The issuer looks up or computes the hash chain value hⱼ associated with the trigger corresponding to the trigger index Iⱼ. The issuer encrypts the inoperative credential with the hash chain value hⱼ as a key and issues the inoperative credential. The card stores the encrypted inoperative credential.

The third major step 530 is making the inoperative credential operative. For each trigger index Iᵢ, the issuer publishes the hash chain value and associated trigger index. hᵢ=H( . . . i-times . . . H(r) . . . ). If the trigger having trigger index Iⱼ occurs, the holder uses the hash chain value to decrypt the credential. The inoperative credential is made operative forming an operative credential.

After the inoperative credential has been made operative to form an operative credential, for example, to form a first operative credential, the first operative credential may be updated to form a second operative credential. However, the first operative credential must be encrypted to enable updating to form the second operative credential. The encryption of the first operative credential may be done at the time when the inoperative credential is made operative to form the first operative credential. In updating the first operative credential, the issuer determines the trigger index Iₖ, wherein k corresponds to a trigger that may occur in the future and cause the first operative credential to be updated to the second operative credential. The issuer looks up or computes the hash chain value hₖ associated with the trigger corresponding to the trigger index Iₖ. The issuer issues the first operative credential and encrypts the first operative credential with the hash chain value hₖ as a key. The card stores the encrypted first operative credential.

If the holder skips a trigger in the sequence of triggers, the hash chain value hⱼ associated with a past index j can be computed from a given hash chain value, say hₘ and trigger index Iₘ by traversing the hash chain forward: hⱼ=H( . . . j-m times . . . H(hₘ) . . . ).

The fourth major step 540 is using, or showing, the credential. Given that the credential can be decrypted, using or showing the credential is by providing the operative credential, for example, the first or second operative credential.

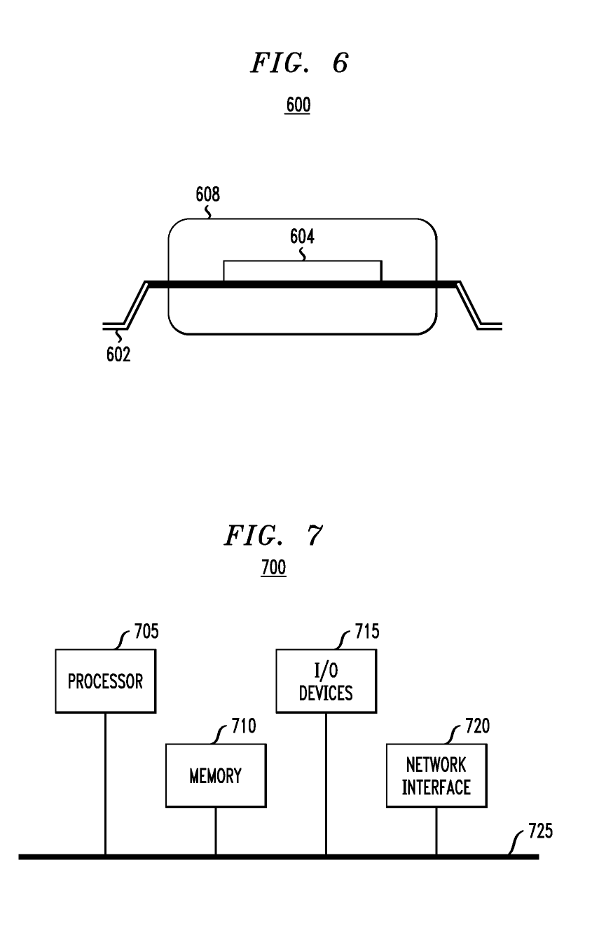

At least a portion of the techniques of the present invention may be implemented in one or more integrated circuits. In forming integrated circuits, die are typically fabricated in a repeated pattern on a surface of a semiconductor wafer. Each of the die includes a device described herein, and may include other structures or circuits. Individual die are cut or diced from the wafer, then packaged as integrated circuits. FIG. 6 is a partial cross-sectional view depicting an exemplary packaged integrated circuit 600, for example, the integrated circuit contained within an eID card, smartcard, or other similar device, or an integrated circuit adapted to perform at least part of one or more methods that are embodiments of the present invention, for example, the methods illustrated in FIG. 1 through FIG. 5. An example of such an integrated circuit is an integrated circuit comprising an inoperative credential issued at a first point in time. The inoperative credential is made operative at a second point in time to form an operative credential. An eID card, smartcard, or other similar device, comprising the integrated circuit, may be issued to an entity or an individual by an enterprise, a government agency, a corporation, a charitable organization, a medical entity, an insurance entity, a financial entity, a financial credit entity, an individual, a computer related entity, a cellular phone provider, a entity requiring electronic identification, a entity requiring secure access, and a entity requiring authentication. The eID card, smartcard, or other similar device may comprise a corporate identity card, a government identity card, a charitable organization identity card, a healthcare identity card, a medical information card, an insurance card, a banking card, a credit card, an attribute enabled bank or credit card, a phone card, and other types of electronic identity cards.

The packaged integrated circuit 600 comprises a leadframe 602, a die 604 attached to the leadframe, and a plastic encapsulation mold 608. One skilled in the art would know how to dice wafers and package die to produce integrated circuits. Integrated circuits so manufactured are considered part of this invention. Although FIG. 6 shows only one type of integrated circuit package, the invention is not so limited; the invention may comprise an integrated circuit die enclosed in any package type.

An integrated circuit in accordance with the present invention can be employed in any application and/or electronic system which makes an inoperative credential operative, updates an operative credential, or uses, reads, or writes eID cards. Suitable systems for implementing the invention may include, but are not limited to, personal computers, communication networks, electronic commerce systems, portable communications devices (e.g., cell phones), solid-state media storage devices, etc. Systems incorporating such integrated circuits are considered part of this invention. Given the teachings of the invention provided herein, one of ordinary skill in the art will be able to contemplate other implementations and applications of the techniques of the invention.

An integrated circuit, a plurality of integrated circuits, discrete circuit elements, or a mix of discrete circuit elements and one or more integrated circuits may be adapted to perform at least part of one or more methods of the present invention.

FIG. 7 illustrates a computer system 700 in accordance with which one or more components/steps of the techniques of the invention may be implemented. In an embodiment of the invention, at least part of one or more methods of the invention, for example, the methods of FIG. 1 through FIG. 5, is executed by processor 705. In another embodiment of the invention, at least part of one or more method of the invention, for example, the methods of FIG. 1 through FIG. 5, is stored in memory 710. It is to be further understood that the individual components/steps of the invention may be implemented on one such computer system or on more than one such computer system. In the case of an implementation on a distributed computing system, the distributed computer system may comprise one or more computer systems implementing aspects of the invention. The individual computer systems and/or devices may be connected via a suitable network, e.g., the Internet or World Wide Web. However, the system may be realized via private or local networks. In any case, the invention is not limited to any particular network. Thus, the computer system shown in FIG. 7 may represent one or more servers, or one or more other processing devices capable of providing all or portions of the functions described herein.

The computer system may generally include processor unit 705, memory 710, input/output (I/O) devices 715, and network interface 720, coupled via a computer bus 725 or alternate connection arrangement.

It is to be appreciated that the term “processor unit” as used herein is intended to include any processing device, such as, for example, one that includes a central processing unit (CPU) and/or other processing circuitry. It is also to be understood that the term “processor unit” may refer to more than one processing device and that various elements associated with a processing device may be shared by other processing devices.

The term “memory” as used herein is intended to include memory associated with a processor or CPU, such as, for example, random access memory (RAM), read only memory (ROM), a fixed memory device (e.g., hard disk drive), a removable memory device (e.g., diskette, compact disk, digital video disk or flash memory module), flash memory, non-volatile memory, etc. The memory may be considered a computer readable storage medium.

In addition, the phrase “input/output devices” or “I/O devices” as used herein is intended to include, for example, one or more input devices (e.g., keyboard, mouse, camera, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although some presented embodiments of the present invention comprise eID cards, the invention is not so limited. Other embodiments comprise other devices that comprise or store operative or inoperative credentials, for example, other smartcards.

Although illustrative embodiments of the invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method of forming a credential, the method comprising the step of:
forming, at a first point in time, an inoperative credential, wherein the inoperative credential is adapted to become operative, at a second point in time, to form a first operative credential, wherein the second point in time occurs after the first point in time, the forming step being performed by a computer system, the computer system comprising a processor device coupled to a computer readable storage medium, and the processor device being configured to execute one or more program instructions embodied in the computer readable storage medium, in order to perform the forming step.

2. The method of claim 1, wherein a trigger functions to initiate making the inoperative credential operative, and wherein, after the second point in time, the first operative credential can be used by at least one of a card, a holder of the card, and a card application.

3. The method of claim 2, wherein the trigger comprises at least one of a milestone, a time, a date, an attribute, a characteristic, a status, an attainment, a privilege, an entitlement, an event, a current place, an attributes of a smartcard reader certificate, a receiving party, a current date signed by a trusted authority, activation by an activation code, and an attainment of at least one of a specific age, marital status, security status, school degree, driving privilege, and social welfare entitlement.

4. The method of claim 1, wherein an electronic identity card stores the inoperative credential.

5. The method of claim 4, wherein the electronic identity card is adapted to card access control, wherein card access control checks for triggers.

6. The method of claim 4, wherein the electric identity card comprises at least one of an electronic health card, a corporate identity card, an insurance card, an attribute-enabled bank card, an attribute-enabled credit card, and a government issued card.

7. The method of claim 2, wherein the trigger comprises a witness of proof that a holder of the inoperative credential possesses an operative second credential.

8. The method of claim 7 further comprising the steps of:
assigning a first number e to be associated with the inoperative credential, wherein the inoperative credential comprises at least one of the first number e and a pointer to the first number e;
assigning a witness number x;
calculating an accumulator number z uniquely corresponding to a set of two numbers according to the formula: z=ƒ(x,e), wherein the set of two numbers comprises the witness number x and the first number e; and
providing the witness number x to at least one of the holder of the card or the card, wherein the witness number x allows calculation of the accumulator number z, and wherein at least part of the witness of proof comprises presenting the accumulator number z.

9. The method of claim 8, wherein the first number e is a prime number, wherein the witness number x and the accumulator number z are withheld from the inoperative credential at the first point in time, wherein the accumulator number z is at least one of: z=x^{e}, z=v^{product (e)}mod n, and z formed according to an RSA public key cryptography algorithm, and wherein v is a seed number.

10. The method of claim 2, wherein the inoperative credential is encrypted, and is decrypted once the trigger occurs.

11. The method of claim 10 further comprising the steps of:
forming a hash chain by using a keyed one-way hash function and a root number r, wherein the hash chain has hash chain values hx, expressed by the equations: h1=H(r), h2=H(h1), h3=H(h2), . . . hn=H(hn−1), wherein x represents a plurality of index values, and wherein H expresses the hash function;
forming a time ordered sequence of triggers comprising a trigger most distant in future time, wherein each trigger, within the sequence of triggers, is associated with one of the hash chain values, and wherein the trigger most distant in future time is associated with the hash chain value h1;
providing at least one of a key to the hash function and a description of the hash function;
encrypting the first operative credential;
providing, the hash chain value for each of the sequence of triggers; and
decrypting the first operative credential after the one of the sequence of triggers has occurred.

12. An article of manufacture comprising a computer readable storage medium having one or more programs embodied therewith, wherein the one or more programs, when executed by a computer, perform step of:
forming, at a first point in time, an inoperative credential, wherein the inoperative credential is adapted to become operative, at a second point in time, to form a first operative credential, and wherein the second point in time occurs after the first point in time.

13. An apparatus comprising:
at least one integrated circuit comprising an inoperative credential issued at a first point in time, wherein the apparatus is adapted for making the inoperative credential operative, at a second point in time, to form an operative credential, and wherein the second point in time occurs after the first point in time.

14. The apparatus of claim 13, wherein the at least one integrated circuit functions as an electronic identity card.

15. The apparatus of claim 13, wherein the apparatus is issued to at least one of an entity and an individual by at least one of an enterprise, a government agency, a corporation, a charitable organization, a medical entity, an insurance entity, a financial entity, a credit providing entity, an individual, a computer, a device requiring electronic identification, a device requiring secure access, and a device requiring authentication.

16. The apparatus of claim 14, wherein the electronic identity card is valid, at least for identification, at least from the first point in time to after the second point in time.

17. The apparatus of claim 14 wherein the electronic identity card is adapted to provide at least one credential.

18. The apparatus of claim 13, wherein the apparatus comprises at least one of a corporate identity card, a government identity card, a charitable organization identity card, a healthcare identity card, a medical information card, an insurance card, a banking card, a credit card, an attribute-enabled bank card, an attribute-enabled credit card, and an electronic identity card.

19. An apparatus comprising:
a memory; and
a processor coupled to the memory configured to: issue, at a first point in time, an inoperative credential, wherein the inoperative credential is adapted to become operative, at a second point in time, to form a first operative credential, and wherein the second point in time occurs after the first point in time.

20. An electronic identity card comprising an inoperative credential issued at a first point in time, wherein the electronic identity card is adapted for making the inoperative credential operative, at a second point in time, to form an operative credential, and wherein the second point in time occurs after the first point in time.
